(19) United States
(12) Patent Application Publication
(10) Pub. No.: US 2005/0220668 A1
(43) Pub. Date: Oct. 6, 2005

(54) Disposable test device with sample volume measurement and mixing methods

(75) Inventor: William E. Coville, Levittown, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Bio/Data Corporation, Horsham, PA (US)

(21) Appl. No.: 11/100,277

(22) Filed: Apr. 6, 2005

Related U.S. Application Data
(60) Provisional application No. 60/559,907, filed on Apr. 6, 2004.

(51) Int. Cl. G01N 31/22

(52) U.S. Cl. 422/57

(57) ABSTRACT

A sample testing device has a volume chamber that separates a known volume of a sample from a remaining sample through the introduction of a fluid between the known volume of the sample and the remaining sample wherein the introduction of the fluid is through a fluid inlet port that has an open and closed state. The device further comprises a passage including a mixing chamber connected to the volume chamber and adapted to mix the sample; a test chamber connected to the mixing chamber and adapted to perform a test on the sample; and a vent port that has an open and a closed state. When the fluid inlet and vent ports are in the open state, the introduction of a pressurized fluid into the fluid inlet port drives the sample from the volume chamber, into one or more mixing chambers, and then into the test chamber.

### CROSS-REFERENCE TO RELATED APPLICATION

This application claims the benefit of U.S. provisional application No. 60/559,907 filed Apr. 6, 2004, which is incorporated by reference as if fully set forth.

### FIELD OF THE INVENTION

The field of the invention is microvolume in vitro test kits.

### BACKGROUND

The analytical and diagnostic test markets need rapid, inexpensive, disposable, microvolume devices and test methods. Clinical, pharmaceutical and biotechnology laboratories are adopting rapid microvolume testing methods. These types of tests are commonly referred to as “lab on a chip” (LOC) or “point of care” (POC) tests.

These rapid, microvolume in vitro diagnostic tests are based on test methods that use whole blood, urine, saliva or other unprocessed body fluids as the test specimen. The tests are packaged as a disposable device containing the necessary reagents. The specimen may be transported within the test cartridge by wicking membranes (lateral flow), capillary action, vacuum or pneumatic pressure. The test results may be determined either visually or with a small instrument. The iterations, classifications and complexity of these devices are varied.

The drawbacks to the existing rapid clinical diagnostic test methods are cost, poor sample quality, inadequate sample volume, inaccurate sample and reagent mixing, poor correlation with standard laboratory tests performed on serum, plasma samples, or other body fluids. Sample variability and interfering substances often cause these conditions. Nevertheless, these methods have been adopted because the market is demanding rapid test results to support immediate medical or other decisions and there are no existing acceptable or proven alternative technologies or products.

In any test, accuracy and precision are critical to performance. The elements for an accurate and precise test or analysis are:
1. Acceptable sample quality is test method dependent. Cellular, matrix, chemical or other interferents must be below established threshold limits. The volume of the active sample is affected by the concentration and condition of the cells, which can vary greatly from 10 to 75 percent of the total volume depending on the patients' physiological condition.
2. Precise sample and reagent volumes.
3. Effective mixing of sample and reagent by controlled dynamic (chaotic) mixing for stoichiometric analysis (law of definite proportions). Dried reagents, especially biological materials, adhere to the walls of the container. The reagents must be completely absorbed into the sample solution and mixed to homogeneity to be effective.
4. Environmental control, accurate control of incubation times and temperatures or other conditions as required by the test method.

An example of current methodology is International Technidyne Corporation's products that utilize whole blood specimens and methods for reagent and sample mixing. Its patents include: U.S. Pat. Nos. 6,451,610; 5,731,212; and 5,372,946. In these devices the whole blood sample is a continuous stream. The sample is moved into a chamber that contains a dried reagent and is moved in and out of that chamber through an orifice that causes the mixing of the sample and reagent. This method has shortcomings: the sample and reagent ratio (volumes) are not accurately controlled; the sample is a continuous stream of which the reagent can diffuse; throughout the entire volume the sample flow over the reagent is laminar, therefore the mixing is not turbulent chaotic or consistent; and the reaction is only partially controlled, limiting the test accuracy, precision, and reproducibility.

### SUMMARY

The apparatus and method according to the invention provide the control, precision and accuracy of the core laboratory analyzer test methodology in a simple disposable device that provides rapid, accurate, reliable, microvolume tests. These tests produce immediate and reliable information and eliminate the requirement for special skills or training of the operator.

A sample testing device comprises a volume chamber that separates a known volume of a sample from a remaining sample through the introduction of a fluid between the known volume of the sample and the remaining sample wherein the introduction of the fluid is through a fluid inlet port that has an open and closed state. The device further comprises a passage including a mixing chamber connected to the volume chamber and adapted to mix the sample; a test chamber connected to the mixing chamber and adapted to perform a test on the sample; and a vent port that has an open and a closed state. When the fluid inlet and vent ports are in the open state, the introduction of a pressurized fluid into the fluid inlet port drives the sample from the volume chamber, into one or more mixing chambers, and then into the test chamber.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments, which are presently preferred. It should be understood, however, that the invention is not limited to the precise arrangements and instrumentalities shown. In the drawings:

FIG. 1 is an illustration of a preferred embodiment of the invention;

FIG. 2 is an illustration of a multiple test configuration according to the invention;

FIG. 3 is an illustration of a multiple mixing multiple reagent and multiple test configuration;

FIG. 4 is an illustration of the direct sample cell integrated into the invention;

FIG. 5 is an illustration of the major components of the direct sample cell and direct test invention;

FIG. 6 is an illustration of a measured fill example according to the invention;

FIG. 7 is an illustration of a measured dispense example according to the invention;

FIG. 8 is a side view illustration of the convex test chamber according to the invention;

FIG. 9 is a top view illustration of the convex test chamber according to the invention;

FIG. 10 thru 15 are illustrations of the sample flow within the invention utilizing static mixing;

FIG. 16 thru 18 are an illustration of the sample flow past a mixing pin and thru a restrictor;

FIGS. 19a-c and 20a-c show common cell varied configurations; and

FIG. 21-23 illustrations of dynamic mixing with a magnetic component.

### DETAILED DESCRIPTION OF THE PREFERRED EMBODIMENTS

### Introduction

The present invention has several advantages over sampling devices in the prior art.

1. Sample Volume Measurement

Sample volume for analysis is precisely measured. The measured sample is then moved discretely through the device to the reagent chamber and then to the test chamber. This provides accurate and reproducible control of the sample and reagent concentrations or ratio. Variations in the sample and reagent ratio will effect the reaction or analysis. Variations in volume as little as 5% can significantly alter the test result.

2. Sample and Reagent Mixing

Static mixing caused by flowing the sample through the dried reagent can be enhanced by two methods. The method used depends on the materials to be mixed, dissolved or re-hydrated by the sample and how vigorous the mixing must be to ensure complete mixing of the reagents. These two methods are direct mixing and diverter mixing.

In direct mixing, a magnetic component, cylinder, ball or other shape is placed in the reagent chamber. When the sample is moved into the chamber, the magnet is moved from one end of the chamber to the other and back one or more times. This motion is driven by electromagnetic fields produced by a moving magnet or an inductor. This motion causes the sample to flow around the magnet against the interior chamber walls, causing higher flow and shear rates, and “washes” the reagent adhered to the walls off and into the sample. The shape of the magnet will affect the mixing dynamics it imparts to the materials. The force of the magnet motion, the frequency of the motion and the duration of the mixing are all individually and precisely controlled and can be programmed for each reagent or test method.

In diverter mixing, a mixing chamber with one or more flow diverters and a full volume passageway causes the sample that has passed over the reagent to be divided, brought back together, and in the process, mixed by turbulent flow. The mixture may be moved back through the mixing chamber several times, as required, for complete dissolution and mixing. The shape of the diverter will affect the mixing dynamics it imparts to the materials. Diverters that are round shaped are preferred, while other shapes such as ovals, rectangles or other shapes are also effective. The force of the fluid motion, the frequency of the motion and the duration of the mixing are all individually and precisely controlled and can be programmed for each reagent or test method.

3. Routine Assay Methods

The test methods can be the same as those used in routine assays in the clinical or other laboratories. This provides direct correlation of results and consistent diagnosis and management of the patient. The current use of whole blood as a specimen yields results that are mathematically manipulated to correlate to the standard laboratory test methodology. Point of care (POC) test results are useful in the area where they are performed, but when the testing is moved to a central laboratory and the test method is changed, the patient result history is often discarded due to differences in the results. The users of POC tests must also be taught to understand the meaning of the various results, which may not fall within normal or expected ranges creating a risk of the results being misleading. This closed assay system eliminates any operator influence that may affect the test results and minimizes biohazardous exposure.

4. Reagents Contained Within the Test Device

Once reconstituted, many reagents have a limited time during which they may be used. This limited stability causes poor, marginal, or variable results over time or reagent waste, because the reagents must be removed and disposed of after the specified time. The device eliminates the need to prepare the reagents, i.e. reconstitution and loading into the device , because the device physically contains the reagents.

Another result of incorporating the reagents within the device and the sample processing and measurement within the device, is the elimination of robotic fluid handling systems that require mechanisms, precision pumps and rinsing or cleaning solutions. This significantly reduces costs and complexity of the analyzer, cost of the rinse solution, and the cost and hazards of the waste disposal.

5. Monitors Sample Quality

In the prior art, there is not any measurement for poor sample quality or imprecise volume, and reagent or mixing issues that affect the test result. In the inventive method, in contrast, the sample quality can be measured when the sample is in the volume chamber by color or turbidity and the sample/reagent mixture optical transmission is measured when the mixture enters the reaction chamber. These measurements are compared to a pre-determined optical transmission level for that test type. This level can have multiple stages such as a warning stage and an abort stage. If the measurement is beyond the limits of a preset range, the test is identified as questionable, initiating examination and thereby minimizing reporting errors.

6. Microfiltration Sample Preparation

Microfiltration sample separation produces plasma, serum or other fluids and eliminates the normal centrifugation process and related artifactual errors, greatly simplifying the test process and reducing the time required to obtain a result by a factor of ten or more, as discussed in U.S. Pat. No. 6,398,956. Using plasma or serum sample test methods, instead of whole blood methods, eliminates interferences from the cellular matter in the whole blood and allows the use of accepted clinical laboratory test methods. The cellular components of the whole blood preclude the use of optical and calorimetric test methods, which are the traditional laboratory methods. The cellular component also adds additional variables to the assay. The rapid test results provide direct correlation to results of the main laboratory that provide for consistent diagnosis and management of the patient. This design will function in a similar manner when the sample is prepared by other methods such as centrifugation.

### DESCRIPTION OF THE EMBODIMENTS

Certain terminology is used in the following description for convenience only and is not limiting. The words “right,” “left,” “lower,” and “upper” designate directions in the drawings to which reference is made. The words “inwardly” and “outwardly” refer to directions towards and away from, respectively, the geometric center of the disposable test device in accordance with the present invention, and designated parts thereof. The terminology includes the words noted above as well as derivatives thereof and words of similar import.

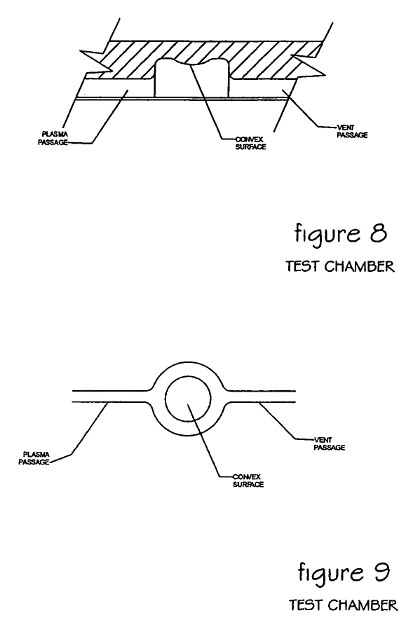

Referring to FIG. 1, a preferred embodiment of a device in accordance with the invention in the form of a single disposable unit 10 is shown. The sample preparation device 10 or sample preparation filtration device comprises a measuring component or volume chamber 12, reagents 14 located in a mixing chamber or area 16, and an analysis portion (test chamber) 18. The measuring component or volume chamber 12 is used to separate an exact volume of sample for a test. The reagents 14 are preferably a dry, lyophilized or liquid, one or several as required. In the mixing chamber 16, the sample and reagent are mixed using a passive or dynamic mixing method, as discussed above. Finally, the analysis portion 18 is shown in FIGS. 8 and 9, and has a convex center (a raised outer top edge out of the optical pathway) to position bubbles or solid objects away from the area of analysis (optical Path). The analysis portion 18 contains an optical path feature that is submerged in the test liquid to displace any bubbles and eliminate any surface effects on the optical transmission.

For ease of use, the device may have identification features (not shown) that identify the test type such as notches, holes, barcodes, colored areas, or writing.

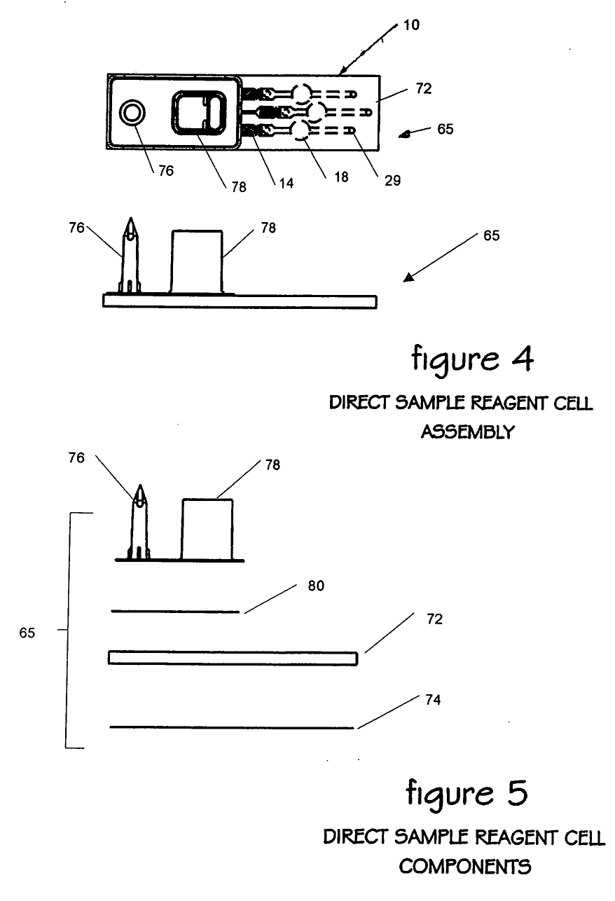

In a preferred embodiment, as shown in FIGS. 4 and 5, the sample preparation device is incorporated into a direct sample reagent cell assembly 65 that filters the sample, for example serum from whole blood through a micro-filtration process, and then delivers the serum directly to measuring chamber 12 of the sample preparation device 10 incorporated therewith. The direct sample reagent cell assembly 65 includes the sample preparation device 10 incorporated into a base 72 and bottom cover 74. A piercing spike 76 and blood sample reservoir 78, preferably integrated in one piece, are attached to the base 72, with the micro-filtration membrane 80 located between blood sample reservoir and the passages in the base 72 which form the measuring chamber(s) 12. The piercing spike 76 is adapted to pierce a specimen tube (not shown) and the reservoir 78 then receives whole blood from the specimen tube via a flow channel, as described in the U.S. Pat. No. 6,398,956, which is incorporated herein by reference as if fully set forth. The membrane 80 is a micro porous membrane that retains the cells above and passes the plasma or serum through to the collection grid in the base, as described in the U.S. Pat. No. 6,398,956. The base 72 is preferably a plastic piece that contains a plasma collection grid on one side and the plasma conduits, reagent mixing chambers and test chamber on the other side. The cover sheet 74 is preferably a plastic film piece that is adhered to the bottom of the base which closes off the plasma conduits.

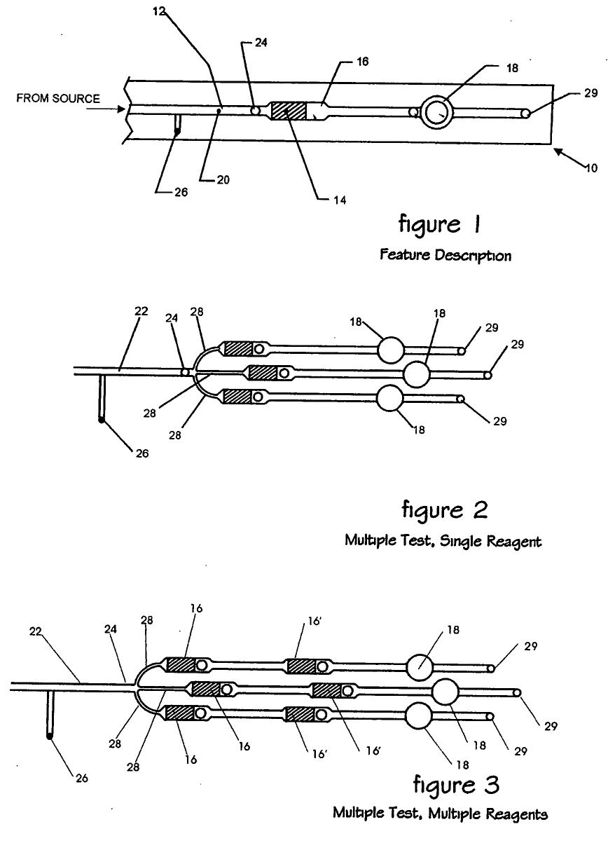

As shown in FIG. 2, in accordance with an alternate embodiment of the device 10′, several adjoining passages 28 connect different mixing chambers 16. These multiple mixing chambers 16 allow for different reagents to be provided in order to run multiple tests at the same time, or to select from one of several available tests. Alternatively, several identical tests can be run at the same time. While three separate test paths are shown, more or less could be provided, as needed.

FIG. 3 shows another alternate embodiment of the device 10″ that provides multiple mixing chambers 16, 16′ along the same passage 28 and also provides multiple passages 28 with multiple mixing chambers 16, 16′. This allows staged mixing of a sample with different reagents, if desired for certain types of tests. Again, the number of test paths 28, as well as the number of mixing chambers 16, 16′ can be varied.

With reference to the figures, the major steps in using the device, (1) sample measurement, and (2) mixing will now be described.
(1) Sample Measurement:

The accuracy of any analysis depends on having an acceptable sample quality, as well as an accurate and reproducible sample volume. The apparatus provides a volumetric measurement of the sample 20 in the volume chamber 12. A volume of sample 20 is moved into the chamber 12 until a volume sensor 24 indicates that the chamber 22 has been filled. At a fixed position along the chamber 12, a connecting passage to an air inlet 26 is provided. This air inlet 26 remains sealed to prevent the sample 20 from flowing into the passage 20. When the sensor 24 senses the presence of the sample 20, the connecting air inlet passage 26 is opened and air, or a compatible liquid at a low pressure, enters through this passage and separates a sample 20 of known volume from the remaining sample, and moves this sample 20 of known volume along the chamber 12.

As shown in FIGS. 2 and 3, it is possible for the measured sample 20 to be directed to different destination points depending on the application.

First, the sample may be directed into one of several adjoining passages 28 as shown in FIGS. 2 and 3. The direction is controlled by venting through one or more of the vents 29 at the end of the selected passage 28 and sealing the passages that are not to be used. This allows for different tests or reagents 14 to be used or selected, and even allows for staged mixing with multiple reagents 14 for a single sample, for example by using the device of FIG. 3.

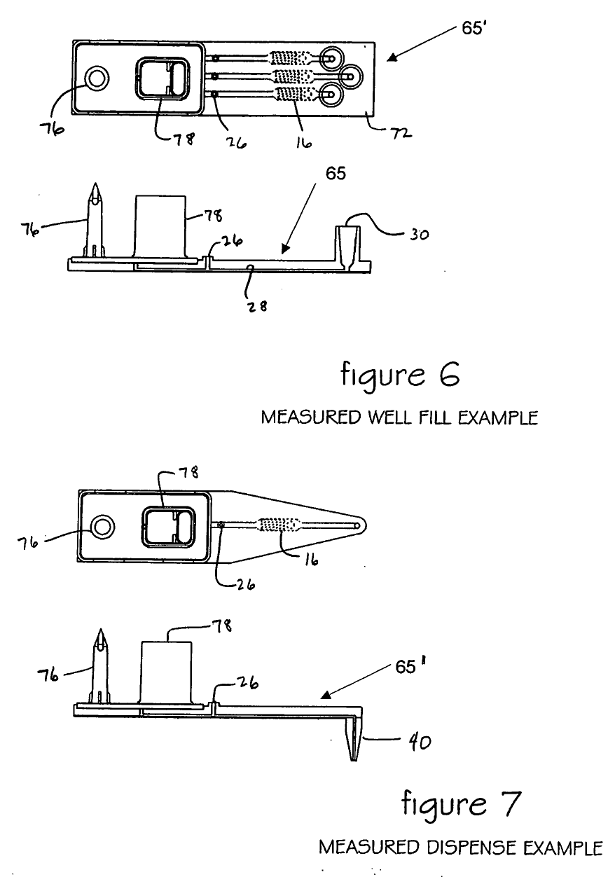

Second, the sample may be directed into an open well 30 as described in the U.S. Pat. No. 6,398,956 and shown in FIG. 6, where the open well 30 is filled up from the bottom eliminating air bubbles or entrapment. This is done using a direct sample reagent cell assembly 65′, similar to 65 discussed above, except that the well 30 is provided instead of or in addition to the test well 18. Using this method, the sample 20 in the well or wells 30 is precisely measured and prepared for analysis.

Third, with reference to FIG. 7, in applications where the sample 20 will be used in different processes, the measured sample 20 is dispensed through a dispense tip 40 or an orifice into another container such as a test cuvette, micro-array or micro-plate (not shown). This can be done with the assembly 65″, which is similar to the device 65 discussed above. Here, the mixing chamber 16 can also be omitted, depending on the particular application.
(2) The Mixing Process:

Obtaining a homogenous mixture is critical to stoichiometric reactions and accurate, precise and reproducible analysis. The sample 20 and reagent 14 must be precisely measured and fully mixed to initiate consistent reaction rates and complete the reaction between the sample 20 and reagent 14. The nature of the materials will define the amount of physical mixing required. Some materials, such as inorganic salts, readily diffuse into solution. Other materials, such as cellular samples, require low shear, gentle mixing. Still other materials require intense physical action to achieve complete mixing. Finally, in many applications, mixing must take place within a fixed time period, at a controlled temperature, as the reactions are usually time and temperature dependent.

When a liquid flows through a passage, a flow pattern described as laminar flow occurs. The liquid near the walls flows at a lesser rate than the liquid at the center because of the drag or friction imparted on the liquid by the surface of the walls. The use of a restriction in the passage or chamber causes some turbulence that enhances the mixing process. The effectiveness of this is dependent on the liquid materials.

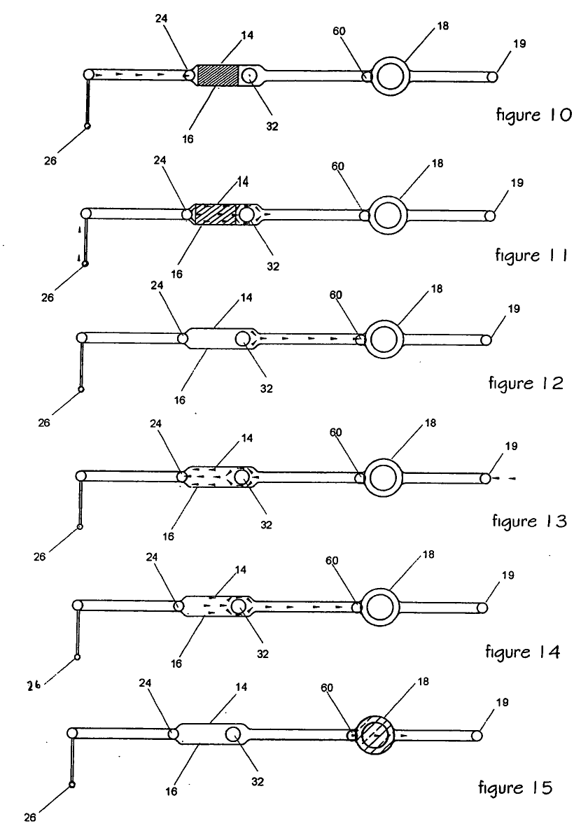

As shown in FIG. 10 through 15, there are two areas of turbulence in the device: at either restricted end of the mixing chamber 16 or in two areas during each pass through the restrictor. A mixing pin 32 is preferably used, which provides some mixing of the sample.

Although the flow pattern splits the mixture and recombines it in a larger area, the basic flow pattern is laminar, which has minimal turbulence resulting in ineffective mixing and an incomplete reaction with variable results. Other methods of inducing mixing include modifying the surface with grooves or steps to disrupt the laminar flow patterns. These methods appear to enhance the mixing on a micro basis. For more on this, see Stroock et al, published in Science vol. 295, 25 Jan. 2002, page 647-651.

Stationary flow disruption mixing is a known method for mixing two materials. In this design, the mixing is performed using restrictors and obstructions to cause turbulence. An unwanted by-product is often shear stress that can cause physical damage to biological materials which may contain large proteins or cellular material. Therefore the flow must be smooth and turbulent so as not to induce high shear stresses.

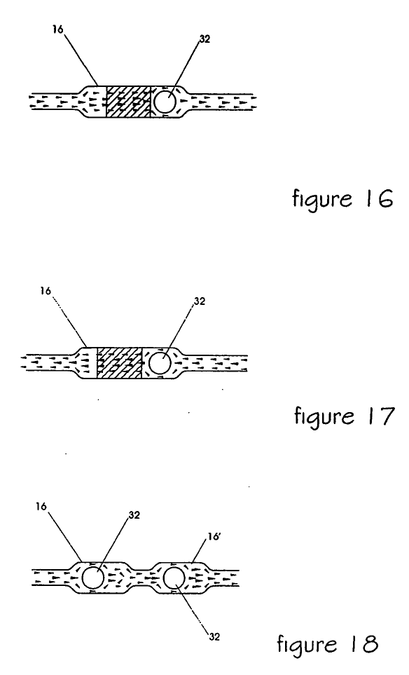

FIGS. 16 and 17 illustrate the flow patterns in the device 10. Note that there are two areas of turbulence, at the beginning of the reagent mixing chamber 16, before and after the mixing pin 32 and at the entrance to the normal flow channel or in four areas during each pass through the restrictor. The two areas around the pin 32 induce a reversed mixing pattern, disrupting the laminar flow completely, resulting in more effective mixing. One or several pins 32 may be used and the pins 32 may be alternated with restricted pathways to further enhance the mixing action as shown in FIG. 18.

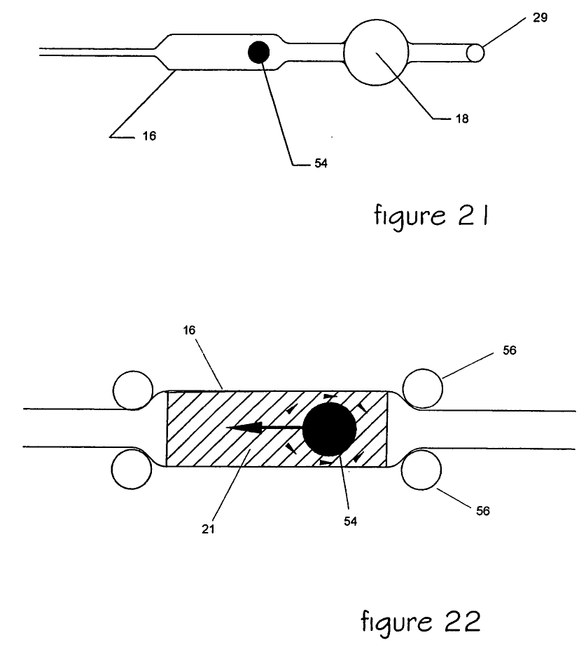

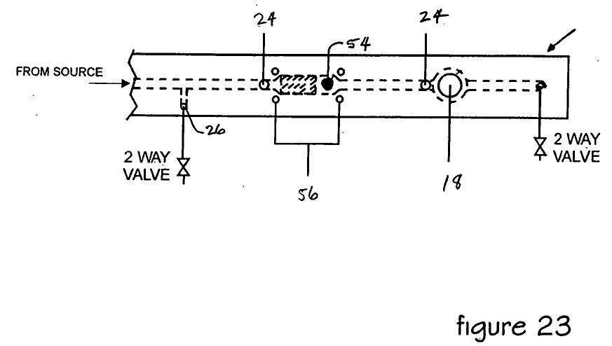

Direct disruptive mixing is another method that can be used in the device 10. As shown in FIG. 21-23, a magnetic mixer 54 is placed in the test device's mixing chamber 16. The size of the magnet 54 is preferably about 75% of the chamber's cross section. When the sample 20 is moved into the chamber 50 the magnetic mixer 54 is moved from one end of the chamber 20 to the other and back or side to side movement one or more times. This movement is induced by electromagnet components 56 such as an inductor whose strength and frequency are controlled by the device.

A moving magnet located outside of the device 10 can be used instead of the inductors 56 in order to move the magnet 54. As this motion is performed, the sample flows around the magnet 54 against the chamber walls and “washes” the reagent 14 adhered to the walls off and into the sample 20. The passages connected to the chamber must be sealed to prevent the sample 20 from being pushed back into the passages. The chamber passage design is such that the mixing magnet 54 cannot obstruct the flow of the sample into or the sample/reagent mixture 21 out of the chamber. Another advantage of this method is that the flow passages of the cell may be shorter, thus allowing for a smaller cell. The reagent 14 is mixed in the mixing chamber 16 and the mixture 21 does not have to flow out of and back into the chamber 16.

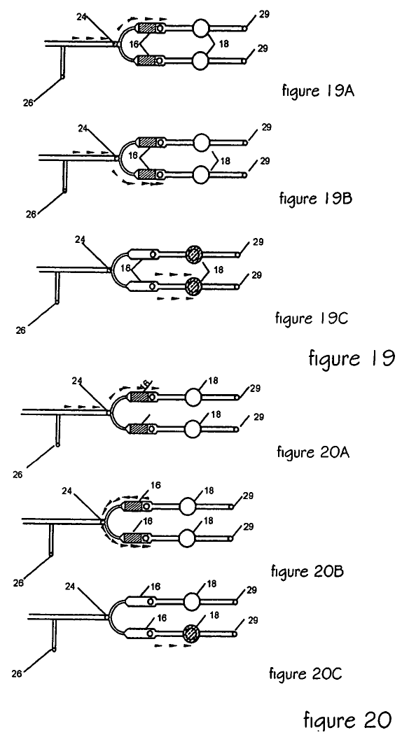

The flow paths through the device 10 may have other shapes than linear, as shown, and in fact could incorporate many variations to perform a particular analysis. For example, FIGS. 19 and 20 show a common cell 12 with two mixing chambers 16, 16′ and two test chambers or wells 18. FIG. 19 shows two tests that use one reagent 14. FIG. 20 shows the same cell 60 used to perform a single test using two reagents. Variations of the shape of the magnet or pin, position of or number of magnets or pins also can be used.

Having described sample measurement and mixing, several embodiments of the invention, with some variations thereon, will now be described.
(1) Single Test, Single Reagent Stationary Mixing Method shown in FIG. 1 (some details in other figures discussed below):
Step 1. Whole blood is transferred into the filtration reservoir 18 (FIG. 2) by the direct sample cell, preferably as shown in FIGS. 4 and 5.
Step 2. The filtration process is initiated. This process continues until sensors detect plasma 20 at the first optical position 24, as shown in FIG. 10, indicating that the chamber 22 is filled. This process produces a predetermined volume of plasma. Sample quality can also be optically measured at this step, to compare the measurement with an expected value or range.
Step 3. Pneumatic fluid pressure is applied at the volume separation inlet 26, as shown in FIG. 11, moving the plasma 20 along the passage, into and through the reagent mixing chamber 16 (as seen in FIG. 12), where it begins mixing with the reagent 14 and travels forward until the plasma/reagent mixture 21 is sensed at the mixing optical detector 60.
Step 4. The process is reversed, FIG. 13, by venting the volume separation inlet 26 and applying pressure to the vent port 29 until the mixture 16 is sensed at the first optical detector 24.
Step 5. The cycle (Steps 3 and 4) will be repeated a predetermined number of times, depending on the mixing required for the reagent type, FIG. 14. This cycle can be programmed in a predetermined cycle.
Step 6. When the mixing cycle is complete, the mixture 21 is moved into the test well 18 by applying pressure until an optical detector (not shown) senses that the test well 18 is filled, FIG. 15.
Step 7. An initial optical transmission measurement can then be made using an optical analysis device, which compares the measurement from the sample to an expected value or range. If this measurement is not within a pre-determined range, the test is identified as subject to examination. This controls sample quality and reagent or mixing issues that would affect the test result.
Step 8. Additional measurements or tests can be made in the test well 18 using an analysis device, for example optically (turbidity, nephelometric or calorimetric), electrically (conductive, impedance, inductance, etc.), or by other methods and the reaction is recorded in the microprocessor.
Step 9. Sensing methods detect the completion of the reaction by measuring the test signal, optical, electronic, etc., an absolute change, the change of signal greater than a predetermined threshold or a rate of change over a period of time.
(2) Single Test, Single Reagent Dynamic Mixing Method shown in FIG. 21 (some details in other figures discussed below):
Step 1. Whole blood is transferred into the filtration reservoir 78 (FIG. 4) by the Direct Sample Cell.
Step 2. The filtration process is initiated. This process continues until the sensor 24 detects plasma having filled the volume chamber 12, shown in FIG. 10. This process produces a predetermined volume of plasma (or volumes if multiple sensors are used).
Step 3. Pneumatic pressure is applied at the volume separation inlet 26, as shown in FIG. 11, moving the plasma along the passage, into the reagent mixing chamber 16.
Step 4. As shown in FIG. 22, once the sample 20 is in the mixing chamber 16, the one or more electromagnets 56 are alternately energized. The magnet 54 is preferably moved straight back and forth from end to end of the chamber 16 or, depending on the inductor position and energizing pattern, may include a side-to-side motion. This cycle will be repeated at a predetermined strength, frequency and duration, depending on the mixing required for the reagent type. These various mixing cycles may be recalled from a stored memory associated with the inductor.
Step 5. When the mixing cycle is complete, pressure applied to the inlet port 26 and venting the vent port 29 moves the mixture 21 into the test well 18. A mixing optical detector (not shown) senses that the test well 18 is filled, as shown in FIG. 15.
Step 6. An initial optical transmission measurement is made and compared to an expected value. If this measurement is not within a pre-determined range, the test is identified as subject to examination. This controls sample quality and reagent or mixing issues that would affect the test result.
Step 7. An analysis device measures the reaction in the test well 18 optically (turbidity, turbidometric, nephelometric or calorimetric), electrically (conductive, impedance, inductance, etc.), or by other methods and the reaction is recorded in the microprocessor.
Step 8. Sensing methods detect the completion of the reaction by measuring the test signal, optical, electronic, etc., an absolute change, the change of signal greater than a predetermined threshold or a rate of change over a period of time.
This method is simpler and faster than moving the sample in and out of the chamber 50 several times and imparts greater mixing action.

(3) Test Method Variations:

The described methods may be altered in at least the following ways.
1. Single Test Multiple Reagents—The device 10 is provided with two or more reagents and mixing chambers, for example as shown in FIG. 3 or 20. The mixing cycle, as described above, is repeated for each reagent shown
2. Multiple Test Single Reagent—As shown in FIG. 2, after the plasma is produced, the measured volume is directed to one or more of several paths. Each path will perform a test, they may be duplicate tests or different types of tests. This is done by:
   a. Venting the path outlet and using the pressure at inlet 26 moves the sample. Additional pressure at the inlet 26 or a vacuum at the vent 29 could also move the sample.
   b. This material is processed until the test begins or there is a delay in the test process, then a second volume is produced.
   c. This second sample is directed to the second path in the same manner as the first sample.
   d. This sequence is repeated until all of the tests are completed.
3. Multiple Test Multiple reagents—As shown in FIG. 3, this is a combination of the two methods described above where there is more than one reagent to be mixed with the sample.
4. In any of the methods, the plasma/reagent mixture can remain in the reagent chamber for a period of time to incubate or activate the mixture. While this is occurring, with multiple test designs, another plasma sample may be processed.

In all of the embodiments of the device, preferably all liquid passages have smooth radii or tapered transitions because sharp corners damage cells, trapped air and cause dead areas without mixing.

Plasma volume measurements are set to account for losses that occur in the transport from the measuring position to the first reagent position in the mixing chamber 16.

Each system specimen volume will be determined by the sample requirements. Typically, the maximum sample volume is equal to 30% of the specimen volume. Lower percentage i.e. 20% provides better sample quality. Both being of better analytical quality than otherwise available for LOC POC tests.

Volumes are specimen type dependent, previous volumes are for Plasma and are about the worse case.

The disposable test device can include an analyzing device that has several functions: filtering the sample from the specimen; incubating the test unit to the required temperature; controlling sample volume independently for each test type; controlling sample reagent mixing actions independently for each test type, measuring optical transmission of the sample / reagent mixture to verify the quality of the sample; analyzing by optical (turbidity nepherometry or calorimetric), electrical (conductive, impedance, inductance, etc.) or other methods.

The analyzer can be configured to: perform direct or indirect analysis such as optical density measurements, immunoassays or calorimetric assays, and allow additional test components (reagents, diluents) that cannot be incorporated within the device to be added.

This description is based on applications in medical diagnostics using whole blood as the specimen and plasma or serum as the test sample. The invention should not however be limited to these specimens or samples, and can include any body fluid (urine, spinal fluid, saliva and so forth) or any liquid sample as used in pharmaceutical, biotechnology or other industrial laboratories (i.e. cell culture or fermentation samples).

1. A sample testing device comprising:
a volume chamber that separates a sample of known volume from a remaining sample through the introduction of a fluid in an entire sample containing both the sample of known volume and the remaining sample;
wherein the introduction of the fluid is through a fluid inlet port that has an open and closed state; and
a passage comprising:
a mixing chamber connected to the volume chamber and adapted to mix the sample;
a test chamber connected to the mixing chamber and adapted to perform a test on the sample;
a first vent port that has an open and a closed state;
wherein when the fluid inlet and first vent ports are in the open state, the introduction of a pressurized fluid into the fluid inlet port drives the sample from the volume chamber, into the mixing chamber, and then into the test chamber.

2. The sample testing device of claim 1 wherein the mixing chamber contains a reagent that mixed with the sample.

3. The sample testing device of claim 1 wherein the fluid introduced is air.

4. The sample testing device of claim 1 wherein the fluid introduced is a liquid that does not react with the sample.

5. The sample testing device of claim 1 further comprising:
at least one additional passage, each comprising:
a mixing chamber connected to the volume chamber and adapted to mix the sample with a reagent contained in the mixing chamber;
a test chamber connected to the mixing chamber and adapted to perform a test on the sample;
a second vent port that has an open and a closed state;
wherein when the fluid inlet is open and either or both of the first and second vent ports are in the open state, the introduction of a pressurized fluid into the fluid inlet port drives the sample from the volume chamber, into and through the passage or at least one additional passage depending on whether the first or second vent port is also in the open state.

6. The sample testing device of claim 1 wherein the passage further comprises:
at least one additional mixing chamber connected to the mixing chamber and adapted to further mix the sample with a reagent contained in the at least one additional mixing chamber.

7. The sample testing device of claim 1 further comprising:
an open well connected to either or all of the volume chamber, the mixing chamber, and/or the test chamber that eliminates air bubbles from the sample.

8. The sample testing device of claim 1 further comprising:
an opening for removing the sample from the sample testing device.

9. The sample testing device of claim 1 further comprising at least one restriction in the mixing chamber that mixes the sample.

10. The sample testing device of claim 9 further comprising a first restriction at an entrance to the mixing chamber and a second restriction at an exit from the mixing chamber.

11. The sample testing device of claim 9 wherein the at least one restriction is a pin.

12. The sample testing device of claim 1 further comprising grooves in the mixing chamber that mix the sample.

13. The sample testing device of claim 1 further comprising steps in the mixing chamber that mix the sample.

14. The sample testing device of claim 1 further comprising a magnetic mixer in the mixing chamber that mix the sample.

15. The sample testing device of claim 14 wherein the cross-sectional area of the magnetic mixer is about 75% of the cross-sectional area of the mixing chamber.

16. The sample testing device of claim 15 wherein the movement of the magnetic mixer is induced by an electromagnet outside of the mixing chamber.

17. The sample testing device of claim 16 wherein the electromagnet is an inductor.

18. The sample testing device of claim 14 wherein the movement of the magnetic mixer is induced by a moving magnet outside the mixing chamber.

19. The sample testing device of claim 1 wherein the mixing chamber can be selectively sealed to prevent fluid flow from an entrance and/or exit therefrom.

20. The sample testing device of claim 1 wherein when the fluid inlet port is in an open state and the vent port is in an open state, the introduction of a pressurized fluid into the vent port drives the sample from the test chamber, into the mixing chamber, and then into the volume chamber.

21. The sample testing device of claim 1 further comprising:
an optical detector that senses the presence of the sample in the test chamber.

22. The sample testing device of claim 21 wherein when optical detector senses the presence of the sample in the test chamber, the introduction of the pressurized fluid to the fluid inlet port is interrupted.

23. The sample testing device of claim 21 wherein the optical detector measures the volume of the sample.

24. The sample testing device of claim 21 wherein the optical detector detects the sample in the passage.

25. The sample testing device of claim 1 further comprising:
an electrical testing device that measures electrical properties of a sample in the test chamber.

26. The sample testing device of claim 1 further comprising an optical testing device.

27. The sample testing device of claim 1 wherein the test chamber has a convex shape that collects bubbles in the sample.

28. The sample testing device of claim 1 wherein the sample is discharged from the device,

29. The sample testing device of claim 1 further comprising:
a reservoir connected to the volume chamber; and
a membrane that filters specimen in the reservoir and allows sample to pass therethrough, the membrane located between the reservoir and the volume chamber.

30. The sample testing device of claim 1 further comprising an analyzing device that performs direct analysis of the sample.

31. The sample testing device of claim 1 further comprising an analyzing device that performs indirect analysis of the sample.

32. The sample testing device of claim 1 wherein the test performed on the sample is an immunoassay.

33. The sample testing device of claim 1 wherein the test performed on the sample is a colorimetric assay.

34. The sample testing device of claim 1 wherein the test performed on the sample is a turbometric assay.

35. The sample testing device of claim 1 wherein the test performed on the sample is an optical density assay.

36. The sample testing device of claim 1 wherein the sample is blood.

37. The sample testing device of claim 1 wherein the sample is plasma.

38. The sample testing device of claim 1 wherein the sample is serum.

39. The sample testing device of claim 1 wherein the sample is saliva.

40. The sample testing device of claim 1 wherein the sample is urine.

41. The sample testing device of claim 1 wherein the sample is spinal fluid.

42. The sample testing device of claim 1 wherein the sample is cell culture or fermentation sample.

43. A method for volume measurement, mixing, and testing a sample comprising the following steps:
separating an exact volume of a sample from a larger sample through the introduction of a fluid between the sample and the larger sample;
mixing the sample with a reagent;
testing the sample; and
driving the sample through each step of the method.

44. A method of claim 43 wherein the sample is driven in two directions through a passage.
